(19) United States
(12) Patent Application Publication
(10) Pub. No.: US 2024/0309670 A1
(43) Pub. Date: Sep. 19, 2024

(54) UTILITY POLE LIFTING APPARATUS AND METHOD

(71) Applicant: AMPJACK INDUSTRIES LTD., Winnipeg (CA)

(72) Inventors: Luke CHAPUT, Winnipeg (CA); Nathan STAHL, Winnipeg (CA); Ben KEBERNIK, Winnipeg (CA)

(21) Appl. No.: 18/606,694

(22) Filed: Mar. 15, 2024

Related U.S. Application Data
(60) Provisional application No. 63/452,990, filed on Mar. 17, 2023.

(51) Int. Cl. B66F 3/26; B66F 3/46; H02G 1/02

(52) U.S. Cl. CPC E04H 12/344; H02G 1/02

(57) ABSTRACT

A utility pole lifting apparatus and method for raising a utility pole in addition to carried transmission cables away from a foundation, without requiring disconnecting or de-energization of the transmission cables. The utility pole lifting apparatus includes a base mounting structure configured to be coupled to the foundation and an upper lifting structure coupled to the base mounting structure and to the utility pole. The upper lifting structure is configured to elevate the utility pole above the foundation while supporting the utility pole and the transmission cables to allow an extension segment to be inserted between the foundation and the utility pole to permanently raise the height of the utility pole.

### CROSS REFERENCE TO RELATED APPLICATION

This application claims priority under 35 U.S.C. § 119(e) to U.S. Provisional Application Ser. No. 63/452,990, filed Mar. 17, 2023, which is expressly incorporated herein by reference in its entirety.

### FIELD OF THE DISCLOSURE

The present disclosure relates generally to lifting equipment, and more specifically to lifting equipment used in the electric utility industry.

### BACKGROUND

The electric utility industry is seeking to correct existing ground or aerial transmission line clearance issues or increase the capacity of existing electric power transmission lines while maintaining the required ground clearance through upgrades to the current transmission infrastructure. Utilities have increased the loads carried by power lines to meet ever-increasing demand during peak loading conditions, such as, for example, those that occur with seasonal heating and air-conditioning loads. This increased line loading creates additional transmission line sag resulting in wire to ground and or object clearance violations. Also, utilities are faced with increasing wire/hardware ground and aerial clearance requirements brought on by erection of nearby structures and/or new codes and/or regulations, which impose new clearance requirements on existing tower line infrastructure.

### SUMMARY

The present disclosure may comprise one or more of the following features and combinations thereof.

In illustrative embodiments, the present disclosure is directed to an electrical transmission pole lifting device for elevating an electrical transmission pole with respect to a foundation of the tower from a first elevation to a second elevation. The utility pole lifting device includes a base mounting structure, configured to allow the base mounting structure to be releasably secured to the foundation of the tower and a series of base brackets that are adapted to provide support for other components in the system.

In illustrative embodiments, the utility pole lifting apparatus also includes an upper lifting structure that is positioned above and connected to the base mounting structure, the upper lifting structure includes a plurality of mounts to allow the upper lifting structure to be releasably secured to the utility pole. The upper lifting structure also includes a series of upper support members and lift shuttles that form the upper lifting structure. Hydraulic lifting cylinders are adapted to be coupled to the lifting structure to lift the utility pole away from the foundation to raise the utility pole to a second elevation. The lifting utility pole apparatus also includes a controller that is configured to control the movement of the hydraulic lifting cylinders to raise the utility pole above the foundation.

These and other features of the present disclosure will become more apparent from the following description of the illustrative embodiments.

### BRIEF DESCRIPTION OF THE DRAWINGS

FIG. 1 is a side elevational view of the utility pole lifting apparatus shown coupled to both a utility pole and its foundation;

FIG. 2 is a perspective view of the base mounting structure secured to the foundation of the utility pole;

FIG. 3 is a perspective view of the utility pole lifting apparatus showing the base mounting structure secured to the foundation, the upper lifting structure coupled to the base mounting structure and to the utility pole prior to lifting the utility pole;

FIG. 4 is a side elevational view of the utility pole lifting apparatus prior to lifting the utility pole;

FIG. 5 is a side elevational view of the utility pole lifting apparatus showing the hydraulic cylinders partially extended to cause the lifting shuttles to travel upward along the upper support members to raise the utility pole above the foundation;

FIG. 6 a perspective view of the utility pole lifting apparatus showing the hydraulic cylinders partially extended to cause the lifting shuttles to travel upward along the upper support members to raise the utility pole above the foundation;

FIG. 7 is a side elevational view of the utility pole lifting apparatus showing the lifting shuttles moved to a second position on the upper support members after the utility pole has been raised a first distance above the foundation to allow the hydraulic lifting cylinders to begin raising the utility pole a second distance above the foundation;

FIG. 8 is a perspective view of FIG. 7;

FIG. 9 is a side elevational view showing the lifting shuttles located in the second position and the hydraulic lifting cylinders having raised the utility pole the second distance above the foundation and a pole extension positioned and installed between the foundation and the utility pole;

FIG. 10 is a perspective view of FIG. 9;

FIG. 11 is another perspective view of the base mounting structure secured to the foundation of the utility pole;

FIG. 12 is a side elevational view of the base mounting structure secured to the foundation of the utility pole;

FIG. 13 is an enlarged view of FIG. 1 showing one of the mounts securing the utility pole to the lifting shuttle;

FIG. 14 is a block diagram of the control system for the hydraulic lifting cylinders;

FIGS. 15-44 illustrate another embodiment of the utility pole lifting apparatus where the lifting apparatus does not use the foundation of the utility pole;

FIG. 15 is a side elevational view of the utility pole lifting apparatus coupled to a utility pole when it is first installed and before the upper portion of the pole is elevated;

FIG. 15a is an enlarged side view of the utility pole lifting apparatus of FIG. 15;

FIGS. 16 and 17 are perspective views of the utility pole lifting apparatus of FIG. 16;

FIGS. 18 and 19 illustrate the upper lifting structure further elevated above lower lifting structure and showing an upper portion of the utility pole separated from a lower portion of the utility pole;

FIGS. 20-22 illustrate the upper lifting structure elevated above the lower lifting structure with the hydraulic lifting cylinders retracted and the shuttle bases repositioned;

FIGS. 23-25 illustrate the hydraulic cylinders partially extended, further raising the upper lifting structure away from the lower lifting structure;

FIGS. 26-28 illustrate the utility pole elevated and a first extension segment having a flange in an upward position aligned with the pole;

FIGS. 29-31 illustrate the utility pole elevated and one or more extension segments aligned with the pole;

FIGS. 32-34 illustrate the utility pole elevated and one or more extension segments aligned with the pole;

FIGS. 35-37 illustrate the hydraulic cylinders now fully extended to raise the upper lifting structure and upper pole section further away from the lower lifting structure;

FIGS. 38-40 illustrate the utility pole elevated a second distance and a second extension segment having flanges at opposite ends aligned with the pole; and

FIGS. 41-43 illustrate the second extension segment coupled to the upper and lower pole sections.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

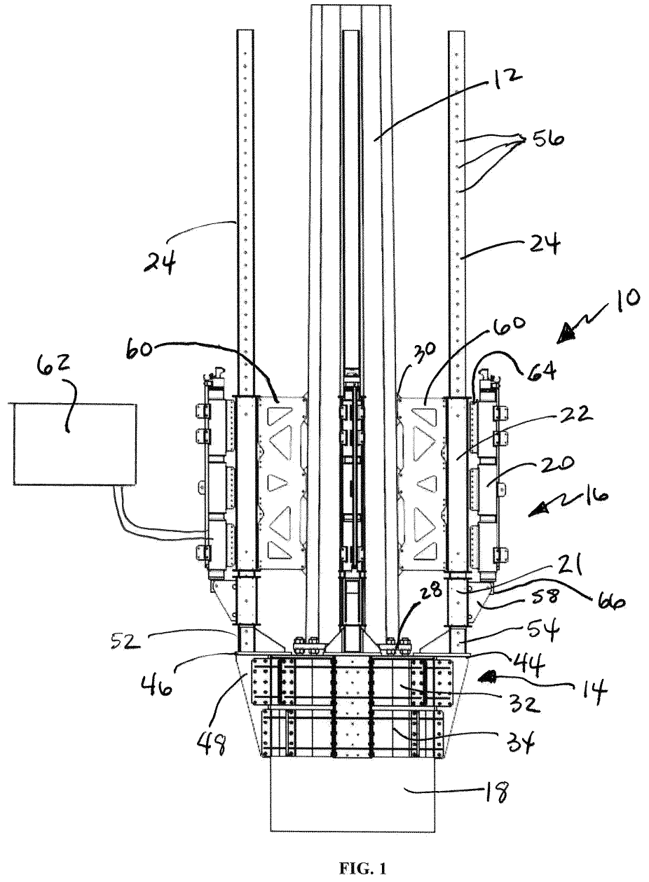

A utility pole lifting apparatus 10 is shown in FIG. 1. Utility pole lifting apparatus 10 is configured for use in connection with electrical transmission and utility poles 12 used in the electrical power industry to raise the utility pole 12 from a first height to a second height to elevate associated power lines.

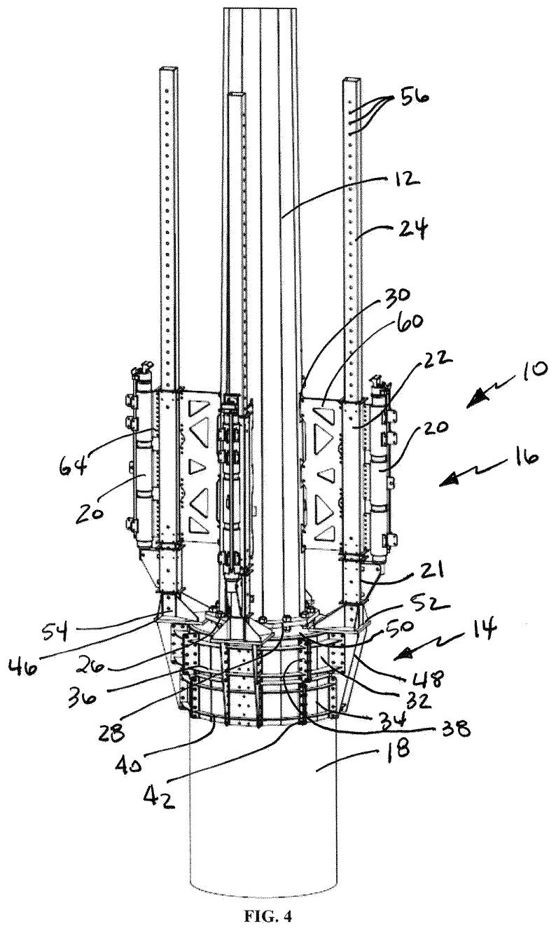

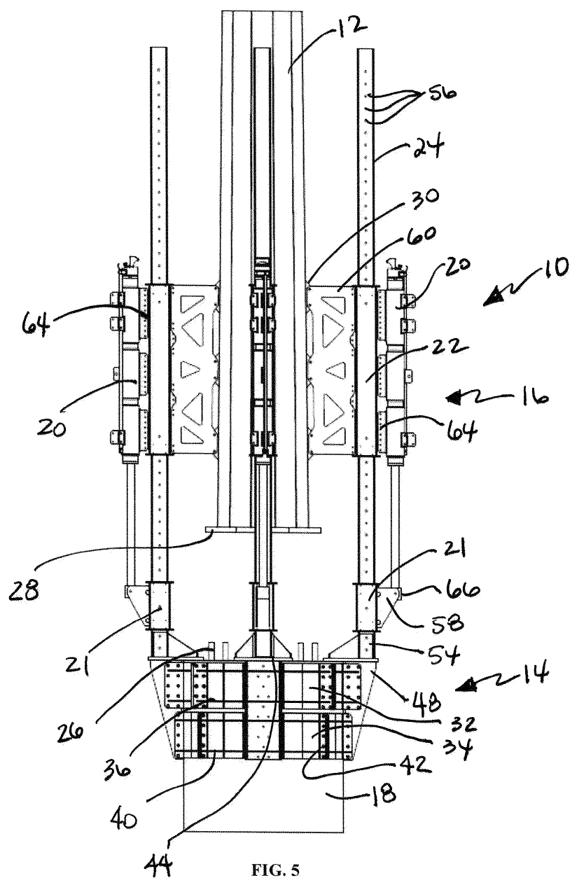

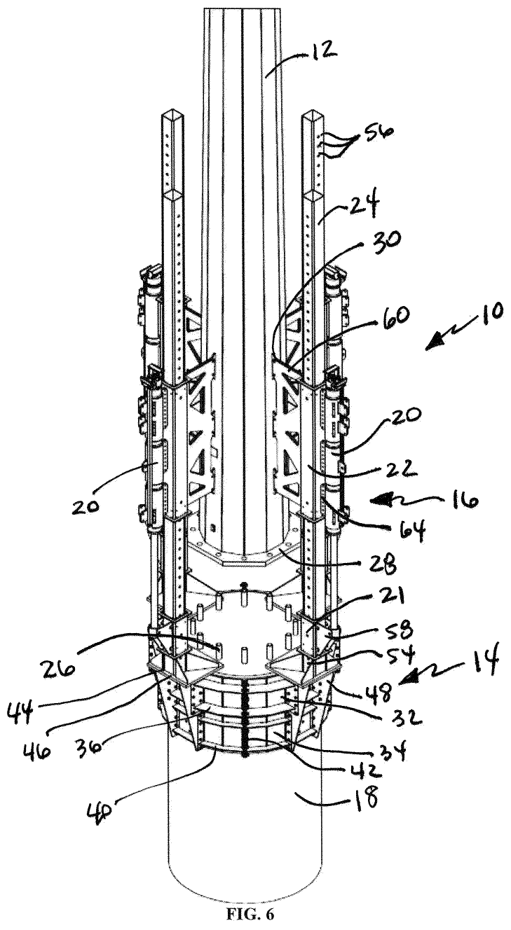

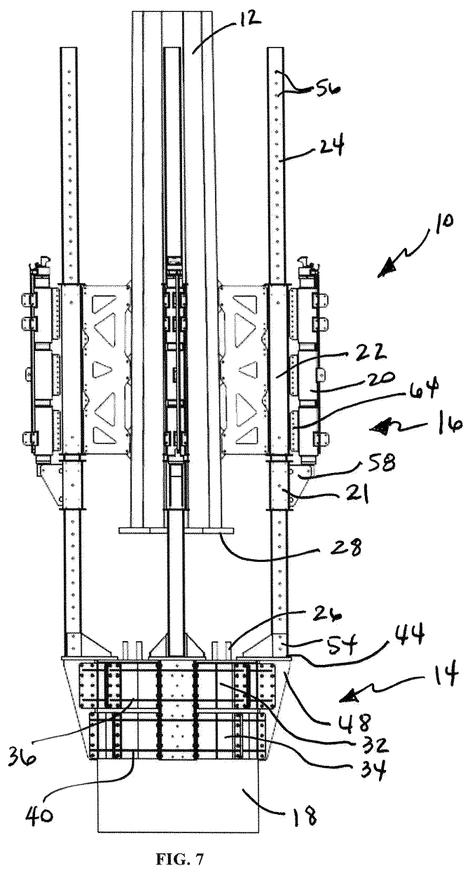

Utility pole lifting apparatus 10 includes a base mounting structure 14 and an upper lifting structure 16. The upper lifting structure 16 is used to raise the utility pole 12 to a first distance from the foundation 18 as shown in FIGS. 4 and 5 and then to a second distance from the foundation 18, as shown in FIGS. 7-9. Upper lifting structure 16 includes four independently controllable hydraulic lifting cylinders 20 that are used to elevate shuttle risers 22 along upper support members 24 and the utility pole 12 away from the foundation 18, as shown in the figures.

Base mounting structure 14 is configured to be secured to the foundation 18 of a utility pole 12, as shown, for example, in FIG. 1. A typical utility pole 12 includes a concrete foundation 18 that is cast into the ground to provide support for the utility pole 12. The foundation 18 is cast with a series of upwardly extending fasteners 26 in the form of bolts that are used to secure a flange 28 of the utility pole 12 to the foundation 18. The utility pole 12, in these applications is typically steel and has a tapered cylindrical shape that narrows as the pole extends upward. The utility pole 12 can have a smooth exterior surface or may have a polygonal shape. As part of the preparation for use of the utility pole lifting apparatus 10, a series of brackets 30 are secured to the utility pole 12 by welding or other means of attachment.

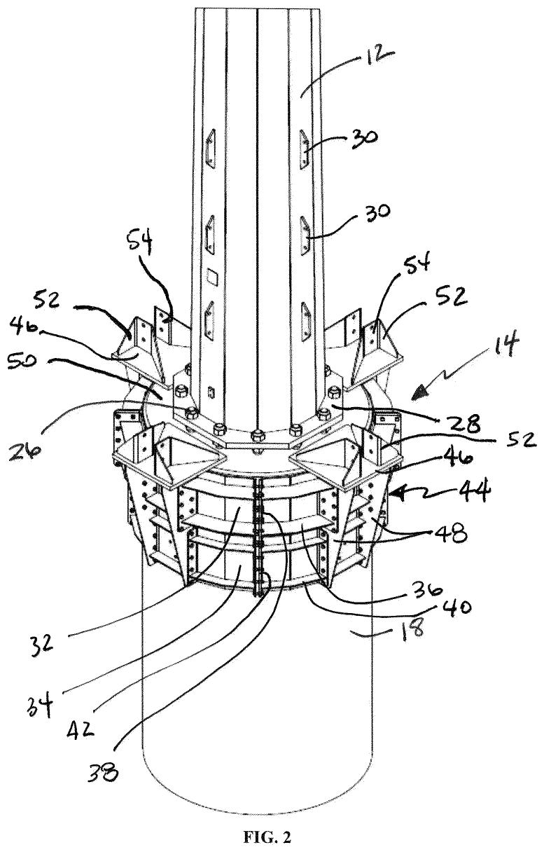

Base mounting structure 14 includes a series of upper and lower collar sections 32, 34 that are shaped to include a radius so that they can conform to the shape of the foundation 18. While upper and lower collar sections are shown, it is contemplated that, depending on geometry and tower loads at the worksite, two, three or four rows of collars may be required to provide the necessary support. Upper collar sections 32 include ribs 36 that provide additional strength to the upper collar sections 32, as shown in FIG. 2. Upper collar sections 32 are secured together by upper collar flanges 38 by use of fasteners. Different size upper collar sections 32 are available to properly secure base mounting structure 14 to the foundation 18. While curved upper collar sections 32 are shown, straight and angled collar sections 32 can also be used if the foundation 18 is square or rectangular or some shape other than cylindrical.

Lower collar sections 34 include ribs 40 that provide additional strength to the lower collar sections 34, as shown in FIG. 2. Lower collar sections 34 are secured together by lower collar flanges 42 by use of fasteners. Different size lower collar sections 34 are available to properly secure base mounting structure 14 to the foundation 18. While curved lower collar sections 34 are shown, straight and angled lower collar sections 34 can also be used if the foundation 18 is square or rectangular or some shape other than cylindrical.

Base mounting structure 14 also includes base supports 44, as shown in FIG. 2. Base supports 44 are used to connect upper lifting structure 16 to base mounting structure 14. Base supports 44 include a base plate 46. Base supports 44 each include a pair of base flanges 48 that extend downwardly from the base plate 46. Base plate 46 includes a lower surface that is configured to rest on top 50 of the foundation 18 to provide stability. Base flanges 48 extend downwardly from base plate 46 and are adapted to be secured to upper and lower collar sections 32, 34 by use of fasteners. The overall diameter of base mounting structure 14 can be altered by changing the number and/or size of the upper and lower collar sections 32, 34. This is dictated by the diameter and shape of the foundation 18.

Base supports 44 each also include a pair of lock flanges 52, as shown in FIG. 2. Lock flanges 52 are secured to and extend upwardly from base plate 46. Lock flanges 52 include mounting plates 54 that include apertures to allow upper lifting structure 16 to be secured. It is preferable to use four base supports 44 to provide proper support around utility pole 12. While four base supports 44 are shown, it may be possible to use more or fewer base supports. For example, it may be possible to use two or three equally spaced base supports 44 to secure the upper lifting structure. It may also be possible to use five or six base supports 44. It is preferable that the base supports 44 are spaced equidistant around base mounting structure 14. Once a utility pole 12 is raised and extension segment 68 is installed, base mounting structure 14 can be removed from foundation 18.

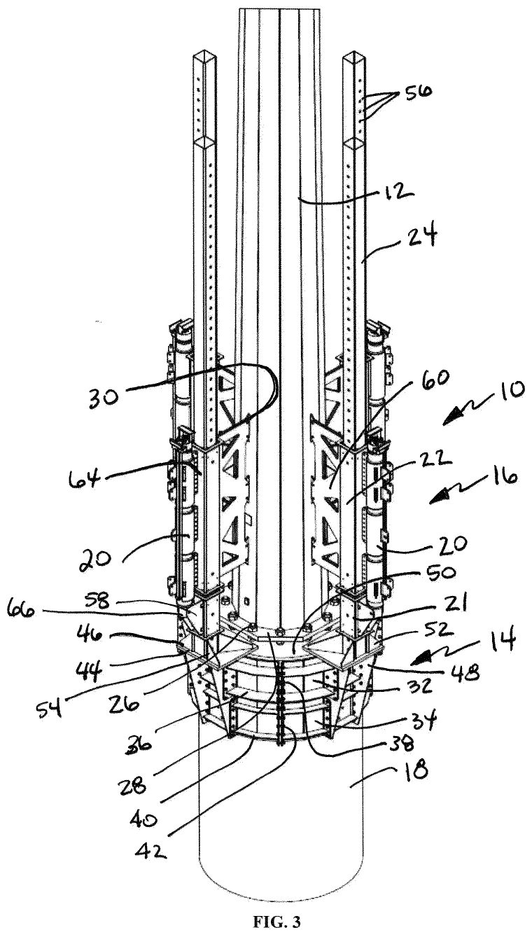

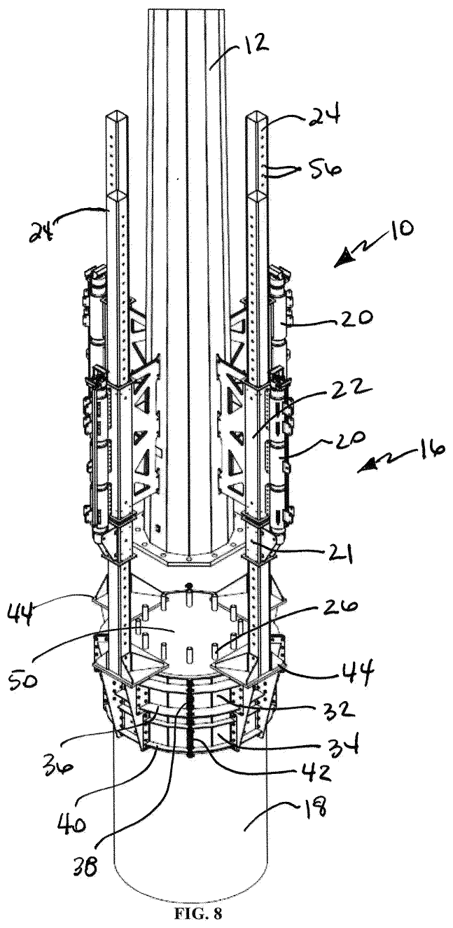

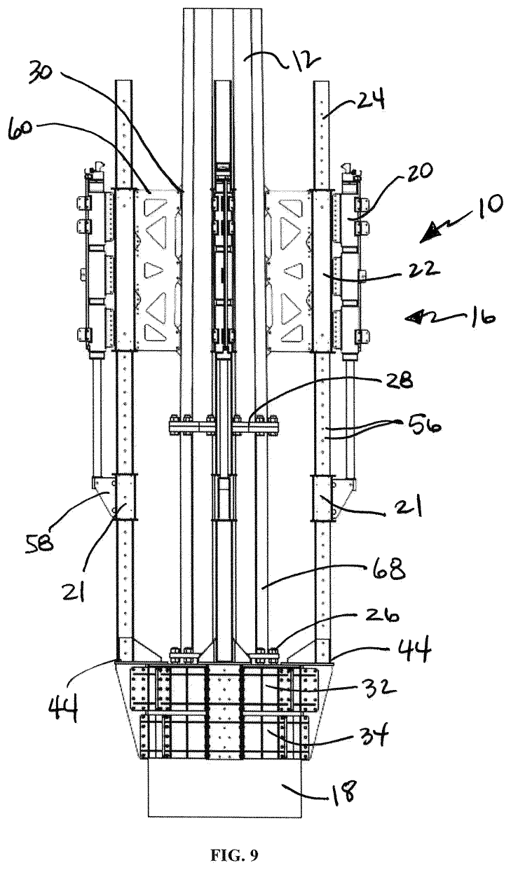

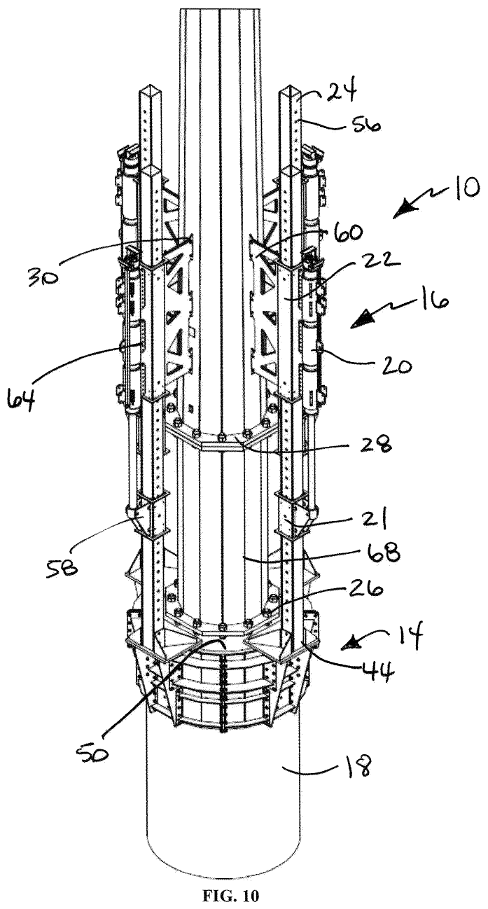

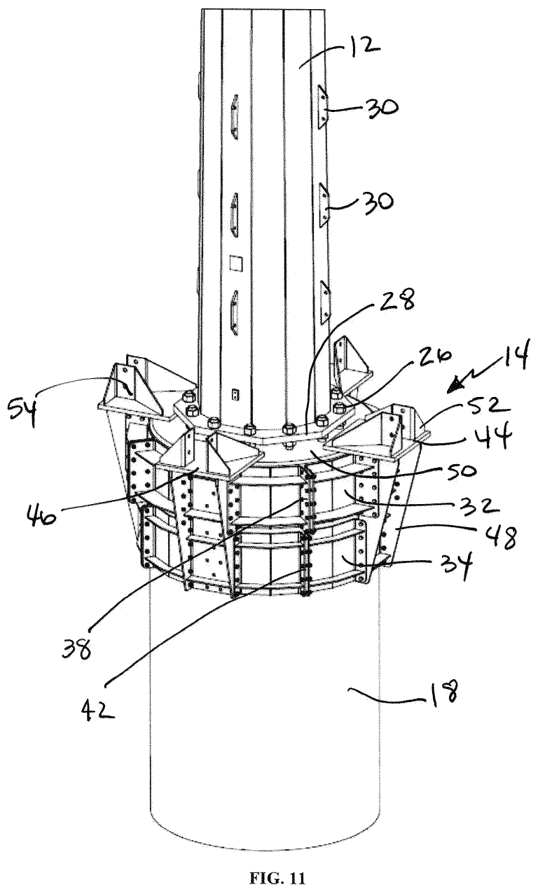

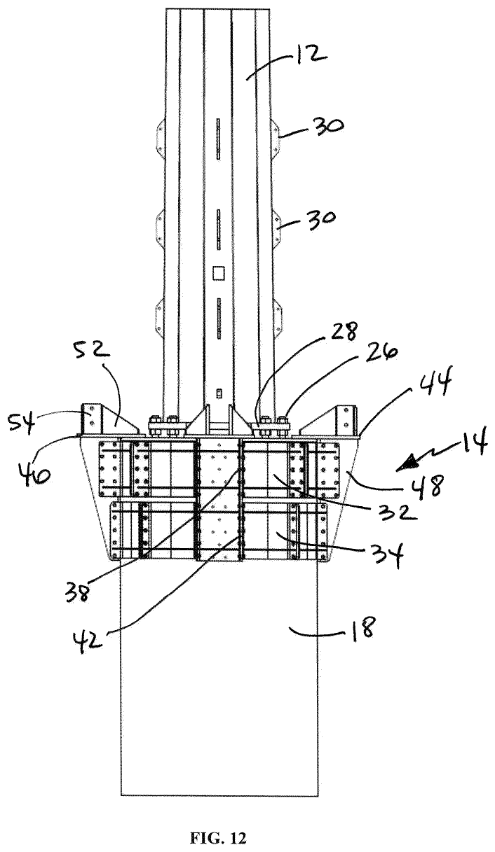

Upper lifting structure 16 of utility pole lifting apparatus 10 is configured to be coupled to base supports 44 of base mounting structure 14, as shown in FIG. 3. Upper lifting structure 16 couples to utility pole 12 and raises it up and away from foundation 18 a desired distance, as shown in FIGS. 7-8 so that a pole extension 68 can be positioned between foundation 18 and utility pole 12, as shown in FIGS. 9-10 to permanently extend pole 12. Upper lifting structure 16 includes upper support members 24 that are secured to mounting plates 54 of base supports 44 by use of fasteners. Support members 24 extend generally vertically and are generally parallel to the other support members 24 and the centerline of utility pole 12, as shown in FIG. 3. Support members 24 are formed to include a plurality of apertures 56 that extend the length of support members 24.

Upper lifting structure 16 includes shuttle bases 21 and shuttle risers 22, which are both positioned around upper support members 24 and are configured to be selectively attached to or move along upper support members 24 depending on the stage of the utility pole lift, as shown in FIG. 3. There is preferably one shuttle base 21 used with each upper support member 24. Shuttle bases 21, are adapted to be coupled to upper support members 24 by use of fasteners. Shuttle bases 21 are secured at its lowest position on upper support members 24 before the lifting of utility pole 12 begins, as shown, for example in FIGS. 1-6. Shuttle base 21 remains in this position until the first lift of the utility pole 12 to a first elevation is completed. To begin the second lift, the shuttle base 21 is unbolted and raised up upper support members 24 to a second position, as show in FIGS. 7-10. Once in the second position, shuttle bases 21 is again secured to the upper support members 24 so that the utility pole 12 can be raised to the second elevation.

Shuttle base 21 of upper lifting structure 16 includes a flange 58 that allows for attachment of lift cylinder 20, as shown in FIG. 5. Shuttle riser 22 is separate from shuttle base 21 and is configured to move away from shuttle base 21 as lift cylinder 20 is extended. Shuttle risers 22 are adapted to be positioned around and extend along upper support members 24. Shuttle risers 22 are adapted to slide along upper support members 24 during the first lift stage. Once the utility pole 12 has been lifted to the first elevation, shuttle risers 22 are fastened to upper support members 24 so that shuttle bases 21 can be uncoupled/unlocked from upper support members 24 and raised and secured to be ready for the second stage lift. Shuttle riser 22 can be coupled to apertures 56 formed in upper support members 24 by use of fasteners, such as bolts. Lifting cylinders 20 are configured to be coupled to shuttle risers 22 so that lifting cylinders 20 can raise shuttle risers 22 along upper support members 24 when energized.

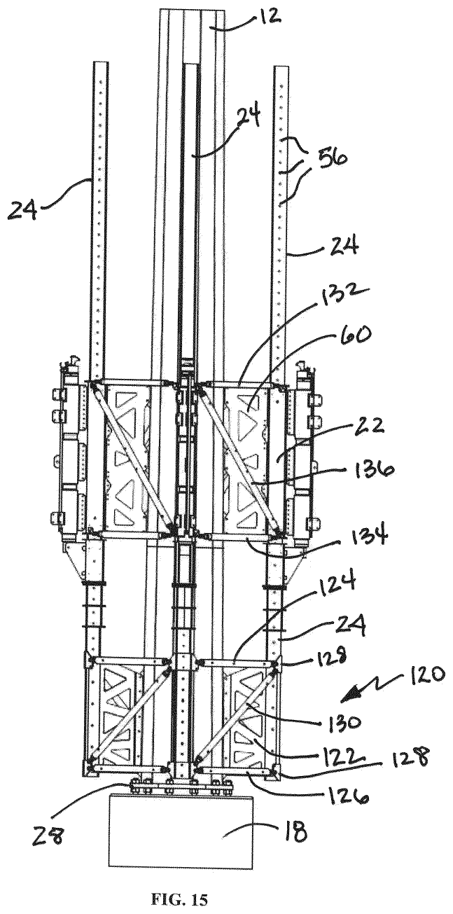

Shuttle risers 22, are interconnected by use of upper and lower cross members 132, 134 and diagonal member 136, as shown in FIG. 15. Cross and diagonal members 132, 134, and 136 are adjustable in length and are used to square upper lifting structure 16 so that shuttle risers 22 are vertically oriented. Cross and diagonal members 132, 134, and 136 are secured to shuttle risers 22 by use of fasteners.

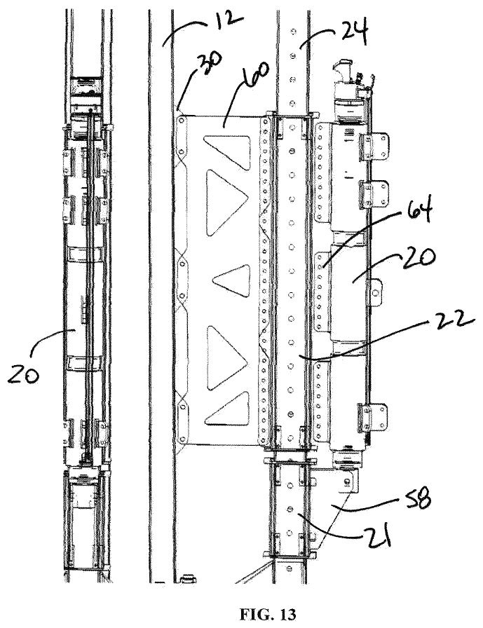

Shuttle risers 22 are coupled to utility pole 12 by use of coupling plates 60 and brackets 30 as shown in FIGS. 1 and 13. Brackets 30 are coupled to utility pole 12 by welding or some other fastening means. Brackets 30 could also be replaced with a clamping mechanism that surrounds and is secured to the utility pole 12 so welding would not be needed. Coupling plates 60 are preferably truss plates that are coupled to multiple brackets 30 at a first end and to multiple locations on shuttle risers 22. In a preferred embodiment, two coupling plates 60 are used for each shuttle riser 22 for a total of eight plates being used. Coupling plates 60 are secured to brackets 30 and shuttle risers 22 by use of fasteners. Coupling plates 60 remain secured to brackets 30 of utility pole 12 during the entire lifting of the utility pole 12.

In a preferred embodiment, the utility pole lifting apparatus 10 includes the four lifting cylinders 20 that are controlled by a hydraulic controller 62, as shown, for example in FIG. 1. Lifting cylinders 20 include upper brackets 64 positioned along the lifting cylinder 20 and a lower coupler 66 positioned at a second end as shown in FIG. 1. Upper brackets 64 are used to secure the lifting cylinders 20 to shuttle risers 22. Lower coupler 66 of lifting cylinders 20 allows lifting cylinders 20 to be coupled to flange 58 of shuttle base 21.

Overall height of utility pole 12 is increased by use of utility pole lifting apparatus 10. Utility poles 12 can be used for supporting power transmission hardware, generally including power transmission conductors or cables, telecommunications cables, grounding, and other electrical hardware and equipment. The utility pole lifting apparatus 10 can also be used with any voltage source including AC or DC and for any voltage level, for low voltage distribution to high voltage transmission and from single circuit to multiple circuit configurations.

The size and number of hydraulic, pneumatic, or electric lifting cylinders 20 are pre-determined based on the weight of the utility pole 12 to be lifted and load carrying capacities of the lifting cylinders 20. While the system illustrated herein includes four lifting cylinders 20, depending on utility pole size and lift requirements a single lifting cylinder may be sufficient or a grouping of four (or more) may be required.

Once lifting and temporary bracing components have been secured, the lifting cylinders 20 are pre-loaded so as to remove tension/compression from the flange 28 by applying pressure from the lifting system in the appropriate direction(s). Pre-loading of the lifting system permits proper loosening of the fasteners 26 on the flange 28 securing the utility pole 12. Once the fasteners 26 are loosened the lifting cylinder pressure(s) are adjusted until the hydraulic lifting cylinders 20 and the upper lifting structure 16 and base mounting structure 14 are taking up the entire static load and then the flange bolts are removed allowing separation of the utility pole 12 from the foundation 18.

Once the utility pole 12 is free from the foundation 18 the hydraulic lifting cylinders 20 can be used to raise the shuttle risers 22 and the utility pole 12 to a desired raised first height as shown in FIGS. 5-8. Accordingly, separation of the utility pole 12 from the foundation 18 begins by initially transferring a load of the utility pole 12 from being directly supported on the foundation 18 to being supported on the foundation 18 through the components of the utility pole lifting apparatus 10.

Once the load of the utility pole 12 and cables is carried by the utility pole lifting apparatus 10, the hydraulic lifting cylinders 20 of the system are uniformly actuated to raise the shuttle risers 22 and the utility pole 12 coupled thereto relative to the foundation 18 coupled thereto from a first elevation to a second elevation. The hydraulic lifting cylinders 20 include respective individual fluid volume controls such that each actuator individually and independently lockable for statically supporting the utility pole relative to the foundation 18 at either one of the first or second elevations or any desired elevation in between.

As the lifting cylinders 20 are fully extended, the utility pole 12 is raised to a first elevation relative to the foundation 18, as shown in FIGS. 5 and 6. At this stage, the shuttle risers 22 are coupled to the upper support members 24 and the shuttle bases 21 are uncoupled from the upper support members 24 and the lift cylinders 20 retract to raise the shuttle bases 21, as shown in FIGS. 7 and 8. Once the shuttle bases 21 are raised, they are again coupled to upper support members 24 and lifting cylinders 20 are energized to provide preload. Once shuttle bases 21 are secured, shuttle risers 22 are uncoupled from upper support members 24 and lifting cylinders 20 lift shuttle risers 22 and utility pole 12 from the first elevation to a second elevation, as shown in FIGS. 9 and 10. Once utility pole 12 is at the second elevation, extension segment 68 is secured between the utility pole 12 and the foundation 18 to permanently raise the utility pole 12 to the desired height. With the utility pole 12 raised, the extension segment 68 is installed in any safe manner as the flanges are secured with fasteners.

The fluid volume controls associated with the hydraulic lifting cylinders 20 permit the hydraulic lifting cylinders 20 to be uniformly extended by delivering a controlled volume of hydraulic fluid to each hydraulic lifting cylinder 20 to evenly and uniformly raise the utility pole 12 relative to the foundation 18 even if some of the hydraulic lifting cylinders 20 are under tension and other hydraulic lifting cylinders 20 are under compression. The controller 62 is also provided with a pressure relief arranged to release the actuation thereof in response to a hydraulic fluid pressure which exceeds a prescribed upper limit indicative of issues with the utility pole 20 or foundation 18.

After ensuring the inserted extension segment 68 is level and plumb all the bolts attaching the extension segment 68 can be torqued to the appropriate specification. Once all the bolts are tightened, the hydraulic lifting cylinders 20 can operated to transfer the load to the inserted extension segment 68 which then supports the utility pole 12 on the foundation 18 at the second elevation. The utility pole lifting apparatus 10 can then be removed with any temporary modifications to the original utility pole 12 including the removal of additional brackets, clamps or bracing restored to pre-lift conditions. Any field welds or holes are to be treated as per the utility specifications to prevent corrosion.

FIG. 1 illustrates a controller 62 that can be used to control the movement of the lifting cylinders 20 in raising the utility pole 12. Controller 62 includes a power switch and lifting cylinder control buttons. When the power switch on the hand held transmitter 112 is activated, it overrides the ground based control unit 62 so the lift cylinders 20 cannot be accidentally activated. Depressing any of the control buttons energizes a particular lifting cylinder 20. Each control button has a corresponding indicator light that indicates when a particular lifting cylinder 20 is activated. Direction and movement of activated cylinders is controlled by lift and lower buttons. Emergency shutoff stops movement of cylinders 20.

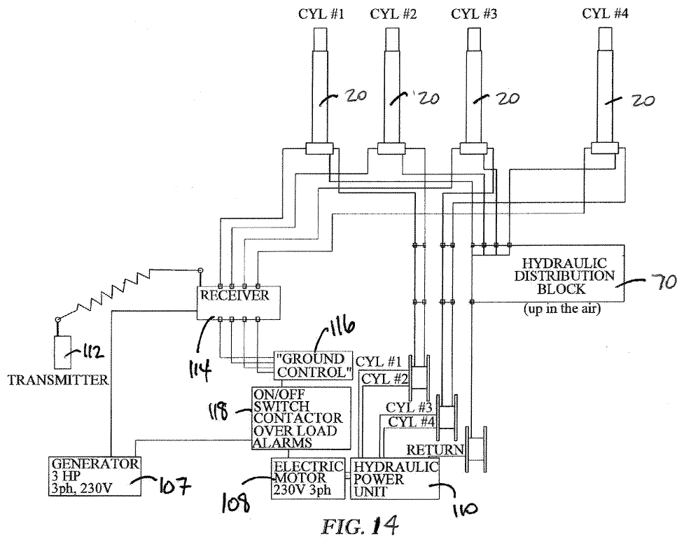

FIG. 14 is a block diagram of the control system for the lifting cylinders 20. The hydraulic lifting cylinders 20 are hydraulic coupled to hydraulic distribution block 70. Hydraulic distribution block 70 controls the flow of hydraulic fluid to and from the lifting cylinders 20. Control system includes a generator 107 that powers an electric motor 108 to power a hydraulic power unit 110. Hydraulic power unit 110 supplies pressurized hydraulic fluid to hydraulic distribution block 70. Control system also includes a wireless transmitter 112 and a receiver 114 to receive signals from the transmitter. Transmitter 112 can be in the form of controller 62. There is also a ground controller 116 that can also be used to control cylinders 20. Control system further includes a main panel 118 that includes power switches, monitors and overload alarms. The intake lines feed directly from the hydraulic power unit to the intake valves on the lifting cylinders 20. The return lines travel from the output valves of lifting cylinders 18 to the hydraulic distribution block 70.

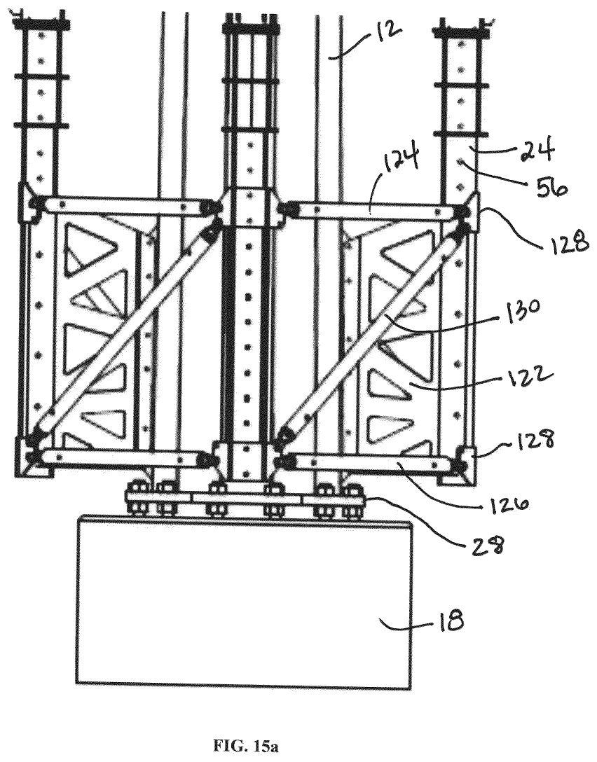

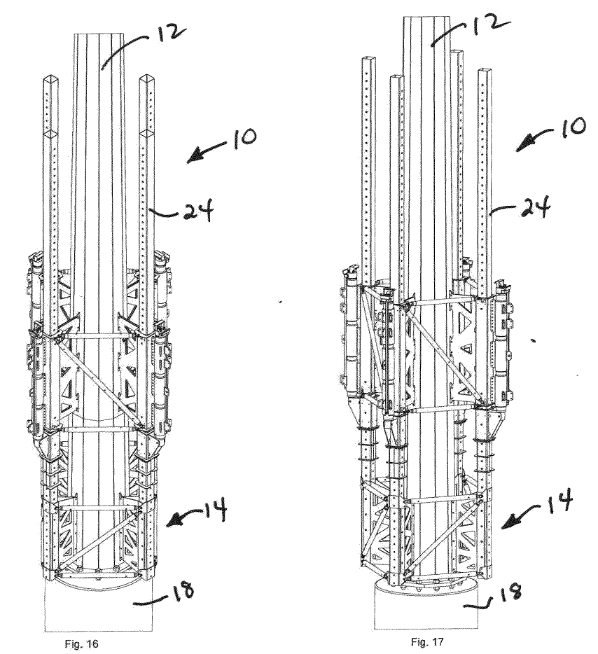

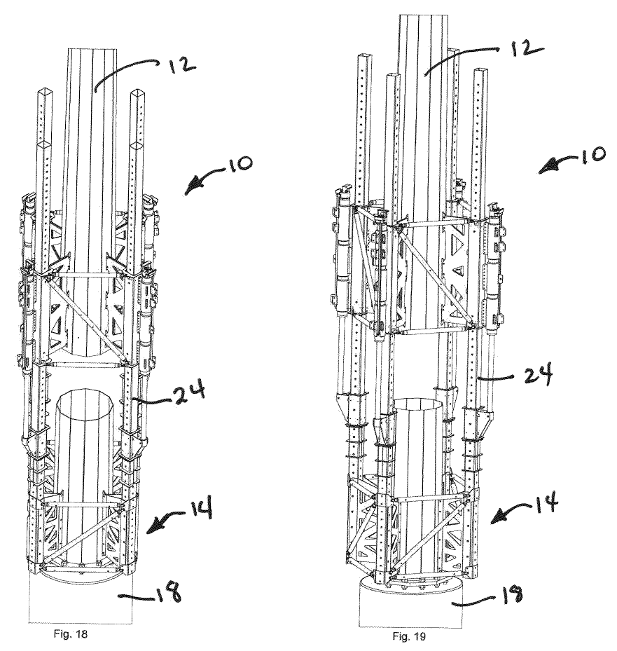

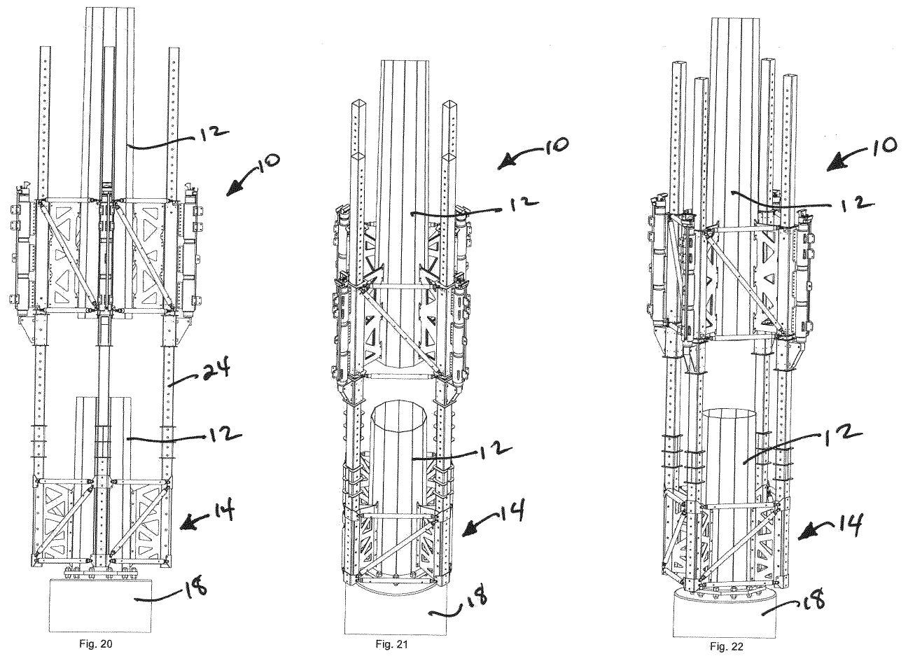

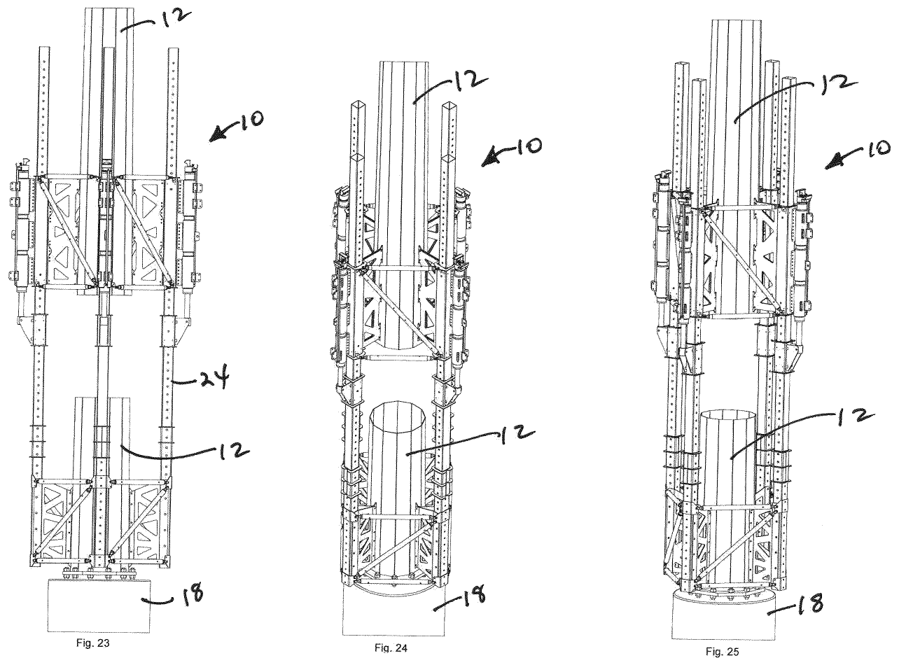

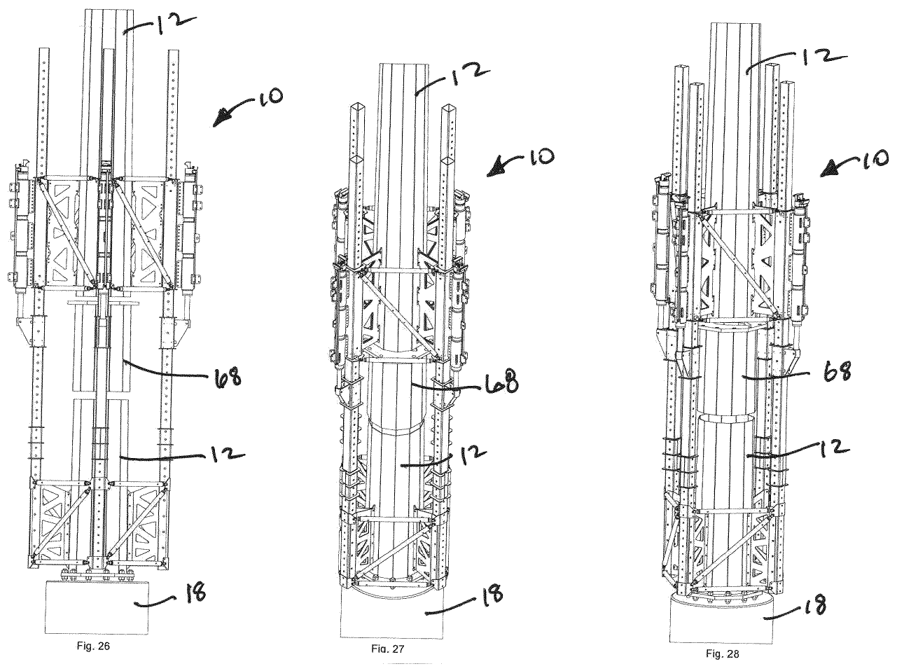

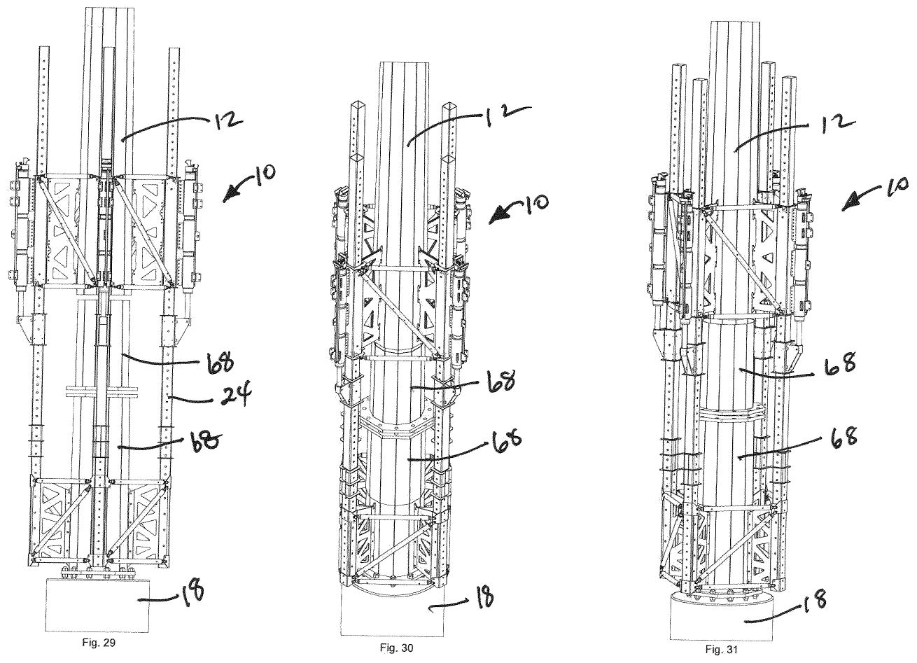

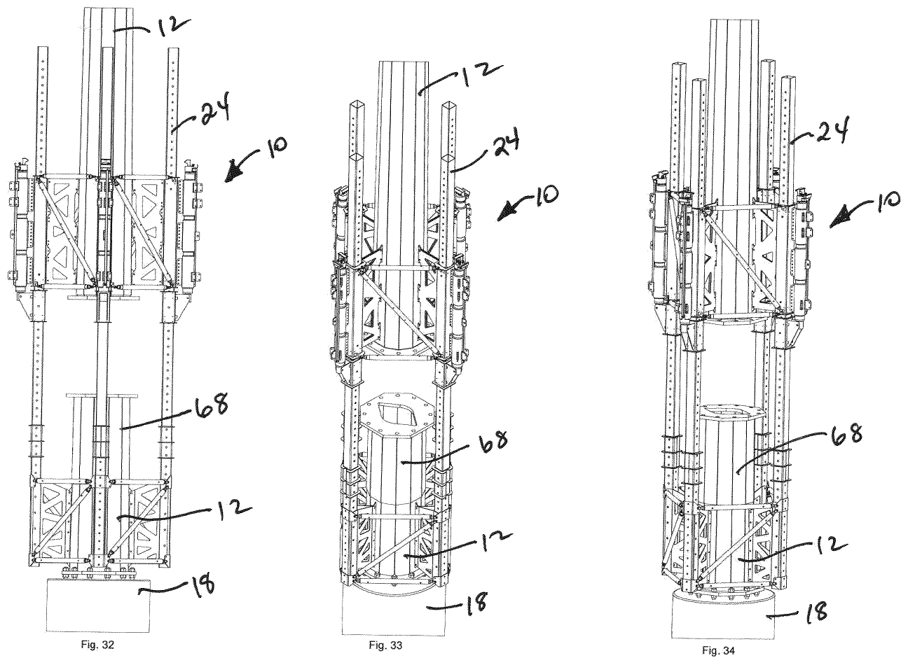

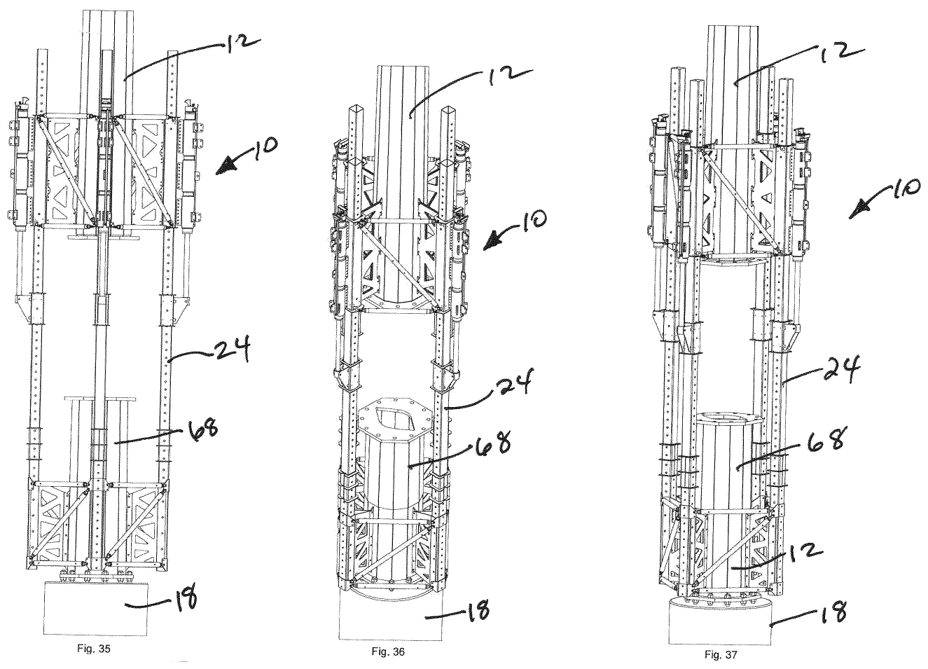

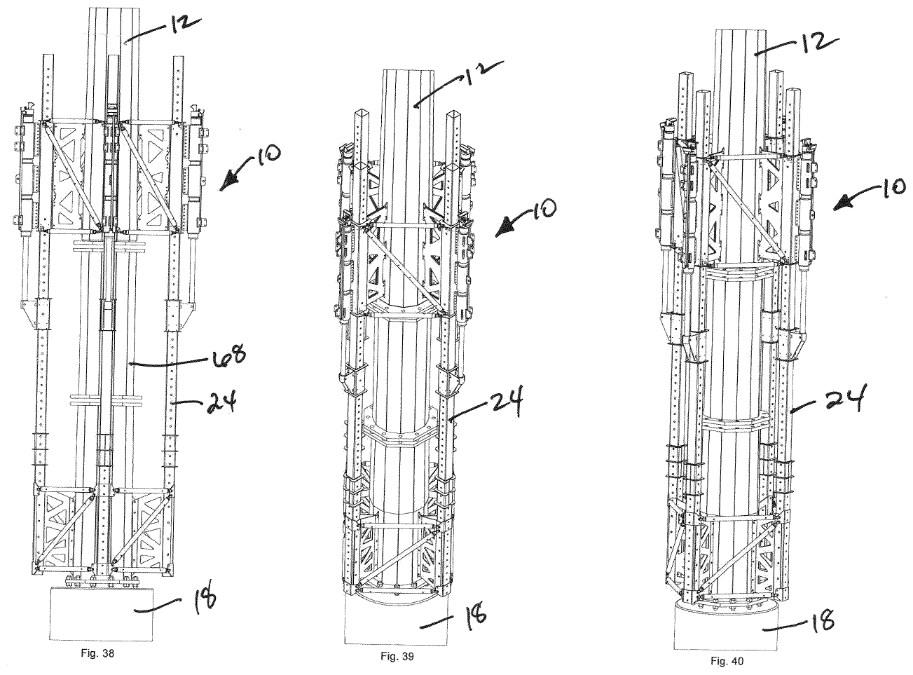

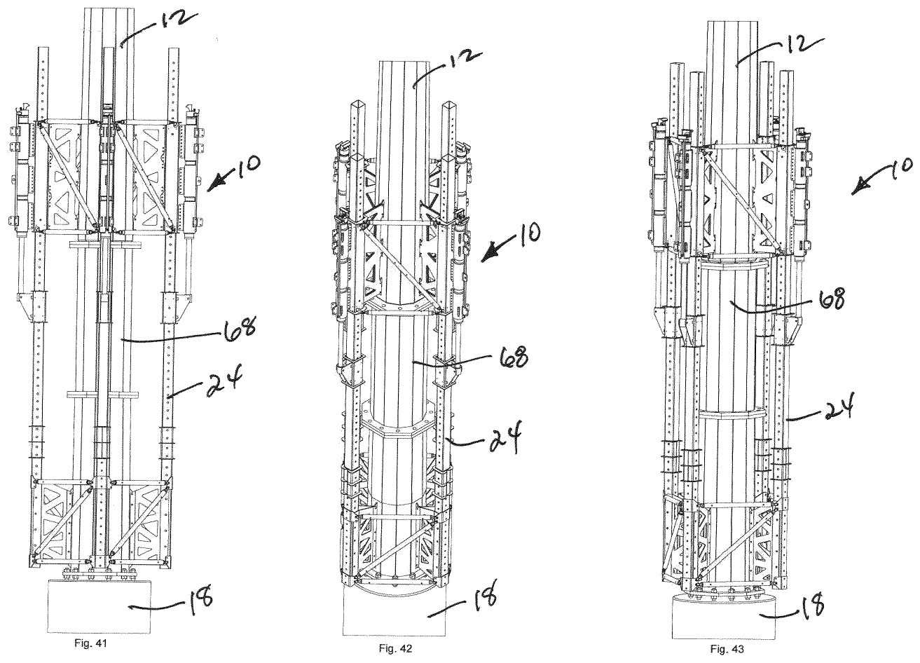

FIGS. 15-44 illustrate another embodiment of the utility pole lifting apparatus showing a direct pole mounted version where the entire lift apparatus is secured to the utility pole 12 and not to the foundation 18.

Lower lifting structure 120 of utility pole lifting apparatus 10 is configured to be coupled to utility pole 12 above foundation 18 and is used to raise upper lifting structure 16 up and away from foundation 18 a desired distance so that the pole extension 68 can be positioned within the gap created in the utility pole 12 to permanently lift pole 12, as shown in FIGS. 15 and 15a. Lower lifting structure 120 includes lower coupling plates 122. Upper support members 24 are coupled to utility pole 12 by use of lower coupling plates 122 and brackets 30.

Brackets 30 are coupled to utility pole 12 by welding or some other fastening means. Brackets 30 could also be replaced with a clamping mechanism that surrounds and is secured to the utility pole 12 so welding would not be needed. Lower coupling plates 122 are preferably truss plates that are coupled to multiple brackets 30 at a first end and to multiple locations on upper support members 24. In a preferred embodiment, two lower coupling plates 122 are used for each upper support members 24 for a total of eight plates being used. Lower coupling plates 122 are secured to brackets 30 and upper support members 24 by use of fasteners. Lower coupling plates 120 remain secured to brackets 30 of utility pole 12 during the entire lifting of the utility pole 12.

Upper support members 24, at their lower ends, are interconnected by use of upper and lower cross members 124, 126 and diagonal member 130. Cross and diagonal members 124, 126, and 130 are adjustable in length and are used to square lower lifting structure 120 so that upper support members 24 are vertically oriented and properly spaced apart. Cross and diagonal members 124, 126, and 130 are secured to upper support members 24 by use of brackets 128 and fasteners (not shown). Use of lower lifting structure 120 allows raising of the utility pole 12 without the need to disturb the foundation or the fasteners that secure the utility pole 12 to the foundation 18. FIGS. 15-44 illustrate the supporting of the utility pole 12 to allow the pole 12 to be severed and raised so that extension segment 68 or segments can be installed in the space created in the utility pole 12 and secured in position. The lifting apparatus 10 can extend the length of the utility pole 12 by providing the base mounting structure that includes a collar that allows a user to releasably secure the base mounting structure to the foundation. The base mounting structure including a series of base supports that are spaced around the utility pole. The user couples the base mounting structure to the foundation. Next, the upper lifting structure is positioned above and connected to the base mounting structure. The upper lifting structure includes a plurality of upper support members that are generally parallel with a centerline of the utility pole.

The upper lifting structure also includes a plurality of shuttles that are configured to move along the upper support members, wherein the shuttles are adapted to be coupled to the utility pole with a plurality of coupling plates to releasably couple the upper lifting structure to the utility pole. At least one actuator is coupled to the upper lifting structure and is used to assist in moving the shuttles along the upper support members away from the base mounting structure to raise the utility pole to the first elevation. The user next couples the upper lifting structure to both the utility pole and the base mounting structure and actuates the actuator to raise the utility pole relative to the foundation from a first elevation to a second elevation. Once the first lift height is achieved, the user repositions the shuttles so the utility pole can be raised relative to the foundation to another elevation. The third elevation is beyond the lift range of the actuators used to elevate the utility pole from the first elevation to the second elevation so the repositioning of the shuttles allows for further lift of the utility pole. Once the utility pole is raised, the user fixes an extension segment between the foundation and the utility pole. Once the extension is in place, the base mounting structure and upper lifting structure are removed from the base and utility pole.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. An electrical or communication transmission utility pole lifting apparatus for elevating a utility pole with respect to a foundation of the utility pole to a first elevation, the lifting apparatus comprising:
a base mounting structure, having a collar to allow the base mounting structure to be releasably secured to the foundation, the base mounting structure including a series of base supports that are spaced around the utility pole;
an upper lifting structure, that is positioned above and connected to the base mounting structure, the upper lifting structure having a plurality of upper support members that are generally parallel with a centerline of the utility pole, the upper lifting structure further including a plurality of shuttles adapted to move along the upper support members, the shuttles adapted to be coupled to the utility pole;
a plurality of lifting cylinders that are configured to be coupled to the upper lifting structure, the lifting cylinders configured to assist in moving the shuttles along the upper support members away from the base mounting structure to raise the utility pole to the first elevation; and
a controller that is configured to control the movement of the lifting cylinders to raise the utility pole away from the foundation.

2. The lifting apparatus of claim 1, further including a plurality of coupling plates that are configured to releasably couple the upper lifting structure to the utility pole.

3. The lifting apparatus of claim 1, wherein the shuttles each include a shuttle base that is configured to be releasably coupled to one of the upper support members.

4. The lifting apparatus of claim 3, wherein the shuttles each include a shuttle riser that is configured to move along one of the upper support members.

5. The lifting apparatus of claim 4, wherein one of the lifting cylinders is coupled to the shuttle base and to the shuttle riser wherein extension of the lifting cylinder causes the shuttle riser to move away from the shuttle base along the upper support member.

6. The lifting apparatus of claim 5, wherein when the shuttle riser is moved from a first elevation to a second elevation by the lifting cylinder, the shuttle riser is secured to the upper support member and the shuttle base is released from the upper support member so that the lifting cylinder can be retracted to move the shuttle base closer to the shuttle riser along the upper support member from a first elevation to a second elevation.

7. The lifting apparatus of claim 6, wherein when the shuttle base is raised to the second elevation the shuttle base is secured to the upper support member and the shuttle riser is released from the upper support member and the lift cylinder moves the shuttle riser from the second elevation to a third elevation.

8. An electrical or communication transmission utility pole lifting apparatus for elevating a utility pole with respect to a foundation of the utility pole to a first elevation, the lifting apparatus comprising:
a lower lifting structure that is configured to be releasably coupled to the utility pole, the lower lifting structure having a plurality of upper support members that are generally parallel with a centerline of the utility pole;
an upper lifting structure, that is positioned above the lower lifting structure, the upper lifting structure including a plurality of shuttles adapted to move along the upper support members, the shuttles adapted to be releasably coupled to the utility pole;
a plurality of lifting cylinders that are configured to be coupled to the upper lifting structure, the lifting cylinders configured to assist in moving the shuttles along the upper support members away from the base mounting structure to raise the utility pole to the first elevation; and
a controller that is configured to control the movement of the lifting cylinders to raise the utility pole away from the foundation.

9. The lifting apparatus of claim 8, further including a plurality of coupling plates that are configured to releasably couple the upper lifting structure to the utility pole.

10. The lifting apparatus of claim 8, wherein the shuttles each include a shuttle base that is configured to be releasably coupled to one of the upper support members.

11. The lifting apparatus of claim 10, wherein the shuttles each include a shuttle riser that is configured to move along one of the upper support members.

12. The lifting apparatus of claim 11, wherein one of the lifting cylinders is coupled to the shuttle base and to the shuttle riser wherein extension of the lifting cylinder causes the shuttle riser to move away from the shuttle base along the upper support member.

13. The lifting apparatus of claim 12, wherein when the shuttle riser is moved from a first elevation to a second elevation by the lifting cylinder, the shuttle riser is secured to the upper support member and the shuttle base is released from the upper support member so that the lifting cylinder can be retracted to move the shuttle base closer to the shuttle riser along the upper support member from a first elevation to a second elevation.

14. The lifting apparatus of claim 13, wherein when the shuttle base is raised to the second elevation the shuttle base is secured to the upper support member and the shuttle riser is released from the upper support member and the lift cylinder moves the shuttle riser from the second elevation to a third elevation.

15. The lifting apparatus of claim 9, further including a plurality of coupling plates that are configured to releasably couple the lower lifting structure to the utility pole.

16. The lifting apparatus of claim 8, wherein the lower lifting structure is secured to the utility pole with brackets.

17. The lifting apparatus of claim 8, wherein upper support members are interconnected by upper and lower cross members and diagonal members and are adjusted to allow alignment of the upper support members with respect to each other.

18. The lifting apparatus of claim 17, wherein the shuttles are interconnected by upper and lower cross members and diagonal members and are adjusted to allow alignment of the shuttles with respect to each other.

19. A method of raising transmission cables carried by an upright utility pole, the method comprising the steps of:
providing a base mounting structure, having a collar to allow the base mounting structure to be releasably secured to the foundation, the base mounting structure including a series of base supports that are spaced around the utility pole;
coupling the base mounting structure to the foundation;
providing an upper lifting structure, that is positioned above and connected to the base mounting structure, the upper lifting structure having a plurality of upper support members that are generally parallel with a centerline of the utility pole, the upper lifting structure further including a plurality of shuttles adapted to move along the upper support members, the shuttles adapted to be coupled to the utility pole with a plurality of coupling plates to releasably couple the upper lifting structure to the utility pole;
at least one actuator configured to be coupled to the upper lifting structure, the actuator configured to assist in moving the shuttles along the upper support members away from the base mounting structure to raise the utility pole to the first elevation;
coupling the upper lifting structure to both the utility pole and the base mounting structure;
actuating said at least one actuator to raise the utility pole relative to the foundation from a first elevation to a second elevation;
fixing an extension segment between the foundation and the utility pole; and
removing the base mounting structure from the foundation and the upper lifting structure from the utility pole.

20. The method of claim 19, further including the step of repositioning the shuttles so the utility pole can be raised relative to the foundation from the second elevation to a third elevation, wherein the third elevation is beyond the lift range of the at least one actuator used to elevate the utility pole from the first elevation to the second elevation.
